(19) United States
(12) Patent Application Publication
(10) Pub. No.: US 2022/0183270 A1
(43) Pub. Date: Jun. 16, 2022

(54) TREE STAND SYSTEM

(71) Applicant: MB Hunting Products Corporation, Bloomfield Hills, MI (US)

(72) Inventors: Mark Ivan PYTIAK, Birmingham, MI (US); Arthur S. KLEINPELL, II, Charlevoix, MI (US)

(73) Assignee: MB Hunting Products Corporation, Bloomfield Hills, MI (US)

(21) Appl. No.: 17/122,302

(22) Filed: Dec. 15, 2020

(51) Int. Cl. A01M 31/02; E06C 1/12

(52) U.S. Cl. CPC A01M 31/02; E06C 7/48; E06C 1/12

(57) ABSTRACT

A portable stand includes a telescoping ladder and a plurality of pairs of brackets. Each bracket of the plurality of pairs of brackets includes an eyelet, and each of the plurality of pairs of brackets includes a rod that connects each pair of brackets with one another. The portable stand may further include a plurality of straps, and each of the plurality of straps is secured to a corresponding pair of brackets. The portable stand may further include a platform.

### FIELD

The present disclosure relates to portable tree stands.

### BACKGROUND

The statements in this section merely provide background information related to the present disclosure and may not constitute prior art.

Stands (e.g., tree stands) have been used to afford a high vantage point. Such tree stands must be stable and repositionable.

Conventional tree stands require substantial effort for erecting the tree stand from object (e.g., tree) to object. Moreover, conventional tree stands are not particularly mobile and may require use of a vehicle (e.g., an all-terrain vehicle) to transport the tree stand from vantage point to vantage point. Further, care must be taken to ensure a user does not fall while attempting to erect a platform for use with the tree stand.

These issues related to portable stands are addressed by the present disclosure.

### SUMMARY

This section provides a general summary of the disclosure and is not a comprehensive disclosure of its full scope or all of its features.

In a form, a portable stand includes a telescoping ladder and a plurality of straps secured to the telescoping ladder. A platform is removably secured to a top rung of the telescoping ladder, and a strap located near a top rung of the telescoping ladder includes an attachment interface. The platform further includes a mounting bracket, and the attachment interface and the mounting bracket are configured for matingly securing the platform in a weight-bearing position.

In a variation, the portable stand further includes a self-arrestor device.

In another variation, the platform includes a seat.

In a further variation, the platform includes at least one of a restraining member and a tension cable.

In yet another variation, the plurality of straps each include a rachet mechanism and are self-retractable.

In a yet further variation, the attachment interface includes at least one of a mounting bracket and a pin-and-hole arrangement.

In a still further variation, the portable stand includes a plurality of brackets, and each pair of brackets corresponds to a respective strap.

In another form, a portable stand includes a height-adjustable ladder. The height-adjustable ladder includes a plurality of brackets, and each bracket of the plurality of pairs of brackets include eyelets. Each of the plurality of brackets and eyelets are affixed to the ladder and the plurality of brackets and eyelets each correspond to a respective strap. Each strap includes a retractable rachet mechanism.

In a variation, the height-adjustable ladder is telescoping.

In another variation, the height-adjustable ladder further includes a platform removably secured to the height-adjustable ladder. In other such variations, the platform includes at least one of a restraining member and a tension cable. In still further such variations, the platform includes a seat.

In still another variation, the height-adjustable ladder includes a plurality of straps, each of which include a rachet mechanism and are retractable. In other such variations, a strap near a top rung of the height-adjustable ladder includes an attachment interface. In still other such variations, the attachment interface includes at least one of a mounting bracket, a pin-and-hole arrangement, and an attachment rod.

In yet another form, a method of using a portable stand includes extending a telescoping ladder having a platform in a non-weight-bearing position and securing the telescoping ladder to an object. The platform is detached from the telescoping ladder and secured to the telescoping ladder in a weight-bearing position.

In a variation, the method further includes securing the telescoping ladder to the object with a plurality of brackets.

In another variation, the method further includes attaching a user to a self-arresting device.

In yet another variation, securing the platform to the telescoping ladder in a weight-bearing position includes securing the platform to the object with at least one of a restraining member and a tension cable.

In a further variation, securing the platform to the telescoping ladder in a weight-bearing position includes securing an attachment interface located on the platform to a mounting bracket located on the telescoping ladder.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a front perspective view of a tree stand according to the present disclosure wherein a platform is in a nonweight-bearing position;

FIG. 2 is a front perspective view of the tree stand wherein the platform is in a weight-bearing position;

FIG. 3 is a partial side view of the tree stand shown in FIG. 1;

FIG. 4 is a perspective view of the tree stand shown in FIG. 1 in a collapsed configuration;

FIG. 5 is a top view of the tree stand shown in FIG. 1; and

FIG. 6 is a partial side view of the tree stand shown in FIG. 1 with a platform with an alternate attachment interface.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

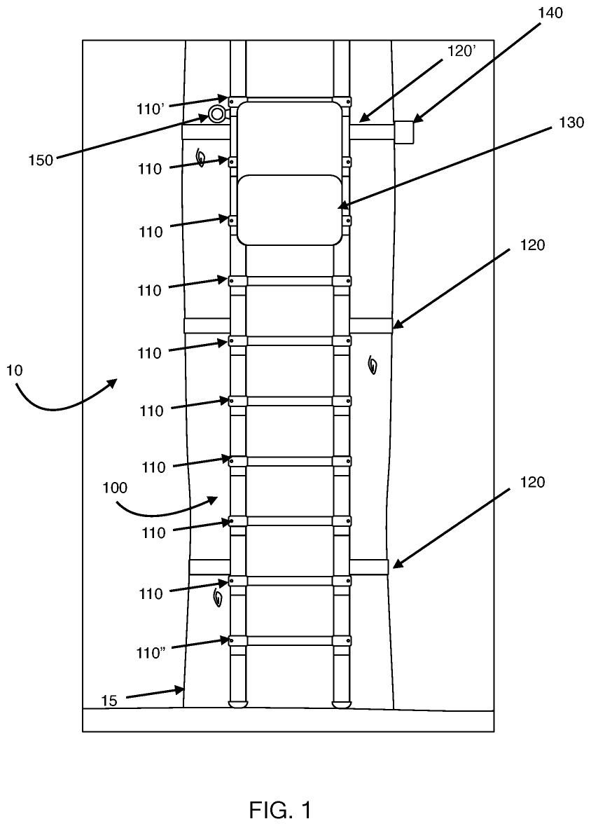

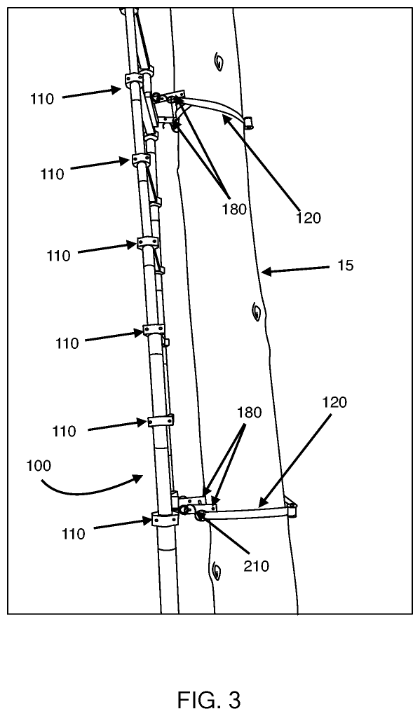

Referring to FIG. 1, a portable stand 10 includes a telescoping ladder 100 (also referred to herein as a height-adjustable ladder) with a plurality of rungs 110 including a top rung 110′ and a bottom rung 110″. While ten rungs 110 are shown, the scope of the present disclosure extends to any number of rungs as needed or desired. The telescoping ladder 100 includes at least a strap 120. While three straps 120 are shown, the scope of the present disclosure extends to one strap, as well as a plurality (i.e., more than one) of straps and may depend on the number of rungs of the telescoping ladder 100. A platform 130 is removably secured to at least one of the rungs 110 of the telescoping ladder 100 in a nonweight-bearing position. According to a variation, the platform 130 is removably secured to the top rung 110′. The rung on which the platform 130 is removably secured may include a groove along a surface of the rung. The platform 130 may have a corresponding mating interface for attaching to the groove along the surface of the rung. The portable stand 10 further includes a mounting bracket 140, which may be located on a top strap 120′. The portable stand 10 may further include a self-arrestor device 150. A user may affix the self-arrestor device 150 to itself such that should the user fall from the telescoping ladder 100, the self-arresting device will stop the user from falling onto the ground. The portable stand 10 may also include at least a pair of brackets 180 (as shown in FIG. 3) to further secure the portable stand 10 to the object 15 (e.g., a tree).

In some variations, the telescoping ladder 100 may be extended or shortened manually, pneumatically, or electronically, among others. As the telescoping ladder 100 is extended, the rungs 110 secure to the telescoping ladder 100 (e.g., with pin-and-hole arrangements formed at predetermined locations) to prevent the ladder from collapsing while in use.

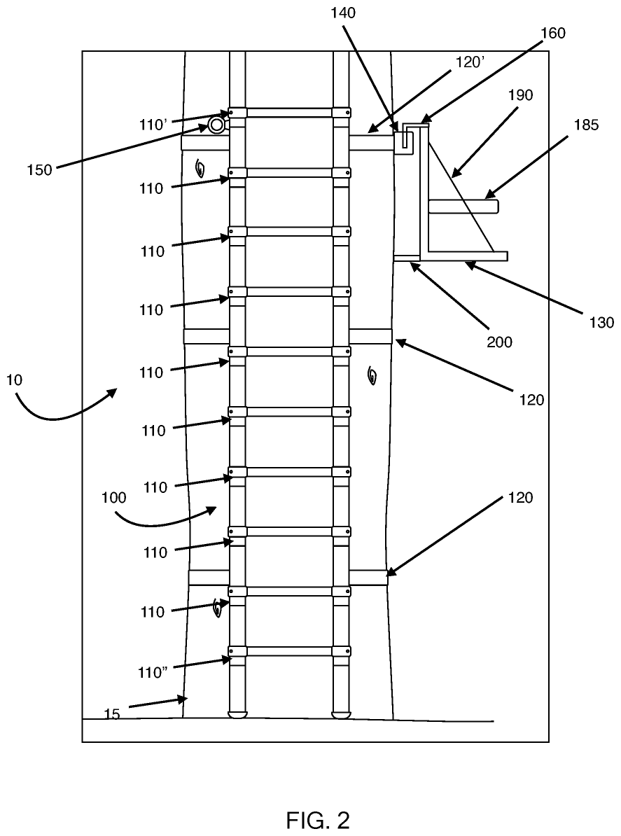

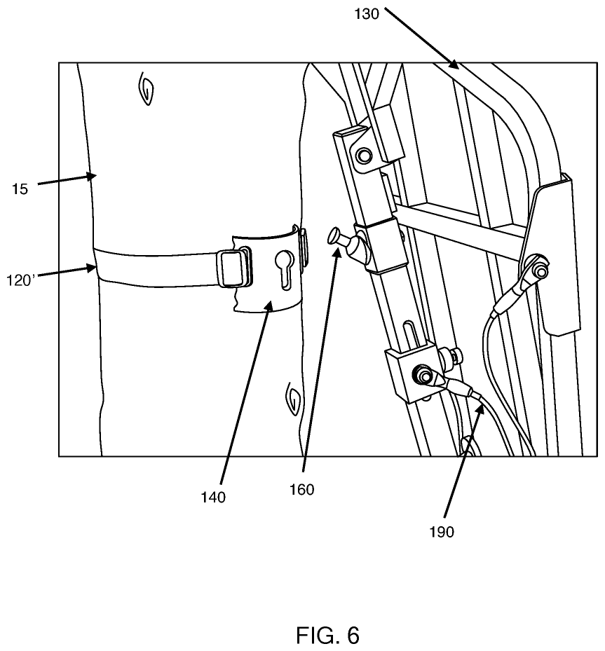

As noted above, the platform 130 is removably secured to at least one of the rungs 110 of the telescoping ladder 100. Turning to FIG. 2, the platform 130 is shown in a weight-bearing position. The platform 130 includes an attachment interface 160 for contacting the mounting bracket 140. As referred to herein, the mounting bracket 140 includes mounting brackets (such as shown in FIG. 1), pin-and-hole arrangements (such as shown in FIG. 6), a cleat, among others. In this fashion, the platform 130 is secured to the telescoping ladder 100 and in effect, the object 15. Further, the platform 130 provides weight-bearing capabilities such that a person and that person's desired accessories can be positioned on the platform 130.

The platform 130 may include a seat 185. To stabilize the platform 130, the platform 130 can further include tension cables 190, restraining members 200, among others.

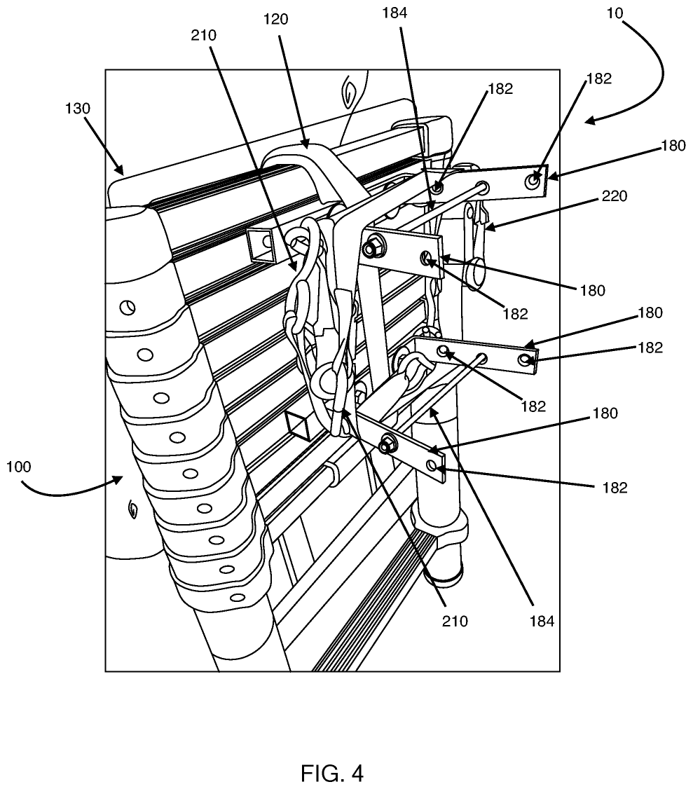

In accordance with a variation, one or more of the plurality of straps 120 may be retractable, and in some variations, self-retractable, such as via a rachet mechanism 220 (FIG. 4), for better portability. Similarly, one of the plurality of straps 120 may or may not be retractable so that it may be used to wrap around a collapsed telescoping ladder as described further herein. As used herein, the term “straps” is intended to mean ropes, rubber straps, bungee cords, and other load-bearing equipment suitable for suspending and preventing falling of the portable stands disclosed herein. The straps disclosed herein also may include hooks 210 (FIGS. 3-4, e.g., hooks, carabiners, among others) for securing the straps to the telescoping ladder, e.g., by securing the hooks 210 to the pair of brackets 180.

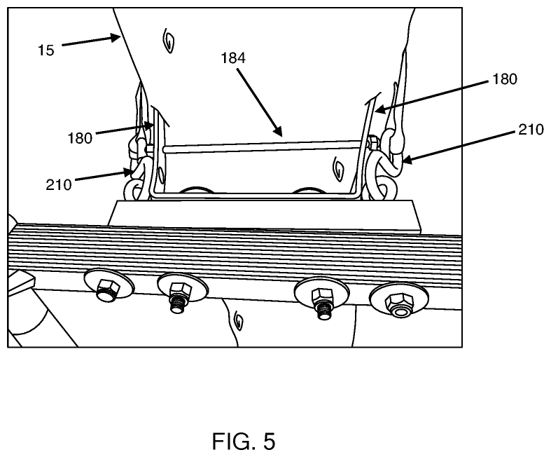

Referring to FIGS. 3-5 and as noted above, the telescoping ladder 100 includes at least a pair of brackets 180. Each bracket 180 includes at least an eyelet 182 for securing a strap 120. Each pair of brackets 180 optionally further includes a rod 184 securing each pair of brackets 180 to one another. Alternatively, each of the plurality of brackets and eyelets are permanently affixed to the telescoping ladder 100. Each set of brackets and eyelets each corresponds to a respective strap 120, wherein each strap 120 may include the rachet mechanism 220 that optionally may be retractable. When a user assembles the telescoping ladder 100, each pair of brackets 180 lodge against the object 15 and stabilize the telescoping ladder 100 against the object 15 when a corresponding strap 120 is wrapped around and tightened against the object 15 and secured to the pair of brackets 180 (e.g., by securing the strap 120 with corresponding eyelets 182). Further, the bracket(s) 180 inhibits the telescoping ladder 100 from directly contacting the object 15, such that as a user climbs the telescoping ladder 100, there is a space between the telescoping ladder 100 and the object 15, thereby allowing the user to safely climb the telescoping ladder 100 without the user's footwear or toes contacting the object 15. Further, as the telescoping ladder 100 is secured to the object 15, a user can climb and descend the telescoping ladder 100 without concern the telescoping ladder 100 will displace from the object 15.

Referring again to FIG. 4, the portable stand 10 is shown in a collapsed configuration. In this configuration, the telescoping ladder 100 is collapsed in on itself. At least one of the plurality of straps 120 may be wrapped around multiple pairs of brackets or the ladder itself 180 to prevent the telescoping ladder 100 from extending. While in a collapsed configuration, the platform may also be mounted to the ladder for transportation and the portable stand 10 can be easily picked up and transported. The portable stand 10 may be carried, e.g., with backpack type straps, and taken to a different location and situated against a different object. Back pack type straps may be attached to the collapsed assembly so that it may be easily carried and transported.

Spatially relative terms, such as “up”, “down”, “side to side”, “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above or below. The device may be otherwise oriented (rotated 90 degrees or at other orientations) and the spatially relative descriptors used herein interpreted accordingly.

The terminology used herein is for the purpose of describing particular example forms only and is not intended to be limiting. The singular forms “a,” “an,” and “the” may be intended to include the plural forms as well, unless the context clearly indicates otherwise. The terms “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A portable stand comprising:
a telescoping ladder;
a plurality of straps secured to the telescoping ladder; and
a platform removably secured to a top rung of the telescoping ladder, wherein a strap located near a top rung of the telescoping ladder includes an attachment interface and the platform includes a mounting bracket, wherein the attachment interface and the mounting bracket are configured for securing the platform in a weight-bearing position.

2. The portable stand according to claim 1, further comprising a self-arrestor device.

3. The portable stand according to claim 1, wherein the platform further comprises a seat.

4. The portable stand according to claim 1, wherein the platform further comprises at least one of a restraining member and a tension cable.

5. The portable stand according to claim 1, wherein the plurality of straps each include a rachet mechanism and are self-retractable.

6. The portable stand according to claim 1, wherein the attachment interface comprises at least one of a mounting bracket and a pin-and-hole arrangement.

7. The portable stand according to claim 1, wherein the portable stand comprises a plurality of pairs of brackets, wherein each pair of brackets corresponds to a respective strap.

8. A portable stand comprising:
a height-adjustable ladder, wherein the height-adjustable ladder comprises a plurality of brackets, wherein each bracket of the plurality of brackets comprise eyelets, and wherein the each of the plurality of brackets and eyelets are permanently affixed to the to the ladder, and wherein the plurality of brackets and eyelets each corresponds to a respective strap, wherein each strap includes a retractable rachet mechanism.

9. The portable stand according to claim 8, wherein the height-adjustable ladder is telescoping.

10. The portable stand according to claim 8 further comprising a platform removably secured to the height-adjustable ladder.

11. The portable stand according to claim 10 wherein the platform further comprises at least one of a restraining member and a tension cable.

12. The portable stand according to claim 10, wherein the platform further comprises a seat.

13. The portable stand according to claim 8 further comprising a plurality of straps, wherein each of the plurality of straps each include a rachet mechanism and the plurality of straps are retractable.

14. The portable stand according to claim 13, wherein a strap near a top rung of the height-adjustable ladder comprises an attachment interface.

15. The portable stand according to claim 14, wherein the attachment interface includes at least one of a mounting bracket, a pin-and-hole arrangement, and an attachment rod.

16. A method of using a portable stand comprising:
extending a telescoping ladder having a platform in a non-weight-bearing position and securing the telescoping ladder to an object;
detaching the platform from the telescoping ladder; and
securing the platform to the telescoping ladder in a weight-bearing position.

17. The method according to claim 16 further comprising securing the telescoping ladder to the object with a plurality of brackets.

18. The method according to claim 16 further comprising attaching a user to a self-arresting device.

19. The method according to claim 16, wherein securing the platform to the telescoping ladder in a weight-bearing position includes securing the platform to the object with at least one of a restraining member and a tension cable.

20. The method according to claim 16, wherein securing the platform to the telescoping ladder in a weight-bearing position includes securing an attachment interface located on the platform to a mounting bracket located on the telescoping ladder.
